(19) United States
(12) Patent Application Publication
(10) Pub. No.: US 2018/0194129 A1
(43) Pub. Date: Jul. 12, 2018

(54) ALIGNMENT METHOD AND DEVICE FOR SCREEN PRINTING PROCESS

(71) Applicants: BOE TECHNOLOGY GROUP CO., LTD., Beijing (CN); ORDOS YUANSHENG OPTOELECTRONICS CO., LTD., Inner Mongolia (CN)

(72) Inventors: Xuansheng WANG, Beijing (CN); Fuyi CUI, Beijing (CN); Junlan JIA, Beijing (CN)

(73) Assignees: BOE TECHNOLOGY GROUP CO., LTD., Beijing (CN); ORDOS YUANSHENG OPTOELECTRONICS CO., LTD., Inner Mongolia (CN)

(21) Appl. No.: 15/730,180

(22) Filed: Oct. 11, 2017

(30) Foreign Application Priority Data
Jan. 6, 2017 (CN) 201710010286.5

(51) Int. Cl. B41F 33/00; B41F 27/00; B41F 15/14; B41N 1/24

(52) U.S. Cl. CPC B41F 33/0081; B41F 27/005; C03C 17/04; B41N 1/248; B41P 2200/40; B41F 15/14

(57) ABSTRACT

An alignment method for screen printing process includes: attaching a transparent film on a to-be-printed substrate in such a manner that the transparent film covers at least a to-be-printed region of the to-be-printed substrate, forming a printed pattern including an alignment mark on the transparent film by using a screen printing plate to imprint printed material onto the transparent film, and comparing whether the alignment mark on the transparent film is aligned with an alignment mark on the to-be-printed substrate. When the alignment mark on the transparent film is aligned with the alignment mark on the to-be-printed substrate, it is determined that current positions of the screen printing plate and the to-be-printed substrate are final alignment positions. When the alignment mark on the transparent film is not aligned with the alignment mark on the to-be-printed substrate, the current position of the screen printing plate or the to-be-printed substrate is adjusted.

### CROSS-REFERENCE TO RELATED APPLICATION

This application claims priority to Chinese Patent Application No. 201710010286.5 filed on Jan. 6, 2017, which is incorporated herein by reference in its entirety.

### TECHNICAL FIELD

The present disclosure is related to the field of printing technology, and in particular to an alignment method and device for screen printing process.

### BACKGROUND

At present, one of packaging methods for organic light emitting diode (OLED) substrates is frit package, which includes: printing a circle of frit on an edge of a package substrate in a screen printing manner, removing organic matter from the frit by baking, and then, by laser sintering, bonding the package substrate and the OLED substrate which are vacuum-bonded, through fused frit. When the package substrate and the OLED substrate are vacuum-bonded, precise alignment is required, and this requires that a printed pattern of the frit formed in the screen printing process perfectly matches with a designed pattern in high precision. Thus, before printing, it is needed to align a screen printing plate with a glass-cover plate. However, the alignment method in the related art is cumbersome, has a large accuracy error and high cost.

### SUMMARY

In view of this, embodiments of the present disclosure provide an alignment method and device for screen printing process, which can solve the problem in the art that the alignment method in the related art is cumbersome, and has a large accuracy error and high cost.

In order to solve the above technical problem, one embodiment of the present disclosure provides an alignment method for screen printing process, which includes: attaching a transparent film on a to-be-printed substrate in such a manner that the transparent film covers at least a to-be-printed region of the to-be-printed substrate, forming a printed pattern including an alignment mark on the transparent film by using a screen printing plate to imprint printed material to the transparent film, and comparing whether the alignment mark on the transparent film is aligned with an alignment mark on the to-be-printed substrate. When the alignment mark on the transparent film is aligned with the alignment mark on the to-be-printed substrate, it is determined that current positions of the screen printing plate and the to-be-printed substrate are final alignment positions, thereby completing alignment of the screen printing plate with the to-be-printed substrate. When the alignment mark on the transparent film is not aligned with the alignment mark on the to-be-printed substrate, at least one of the current position of the screen printing plate and the current position of the to-be-printed substrate is adjusted.

Optionally, after adjusting at least one of the current position of the screen printing plate and the current position of the to-be-printed substrate, the alignment method further includes: removing the transparent film away from the to-be-printed substrate, and performing repeatedly preceding process until the alignment mark on another transparent film is aligned with the alignment mark on the to-be-printed substrate.

Optionally, the transparent film is a polyester film or a nylon film.

Optionally, the transparent film has a thickness in a range of from 0.5 um to 1.5 um.

Optionally, the to-be-printed substrate is a package substrate of an OLED substrate, and the printed material is frit.

One embodiment of the present disclosure provides a screen printing process, which includes: attaching a transparent film on a to-be-printed substrate in such a manner that the transparent film covers at least a to-be-printed region of the to-be-printed substrate, forming a printed pattern including an alignment mark on the transparent film by using a screen printing plate to imprint printed material to the transparent film, and comparing whether the alignment mark on the transparent film is aligned with an alignment mark on the to-be-printed substrate. When the alignment mark on the transparent film is not aligned with the alignment mark on the to-be-printed substrate, at least one of the current position of the screen printing plate and the current position of the to-be-printed substrate is adjusted and the transparent film is removed away from the to-be-printed substrate, and the preceding process performs repeatedly until the alignment mark on another transparent film is aligned with the alignment mark on the to-be-printed substrate. When the alignment mark on the transparent film or the another transparent film is aligned with the alignment mark on the to-be-printed substrate, the transparent film or the another transparent film is removed away from the to-be-printed substrate, and the screen printing plate is used to imprint printed material to the to-be-printed substrate.

Optionally, the transparent film is a polyester film or a nylon film.

Optionally, the transparent film has a thickness in a range of from 0.5 um to 1.5 um.

Optionally, the to-be-printed substrate is a package substrate of an OLED substrate, and the printed material is frit.

One embodiment of the present disclosure provides an alignment device for screen printing, which includes: an attaching member, an implementing member and an adjustment member. The attaching member is configured to attach a transparent film on a to-be-printed substrate in such a manner that the transparent film covers at least a to-be-printed region of the to-be-printed substrate. The implementing member is configured to form a printed pattern including an alignment mark on the transparent film by using a screen printing plate to imprint printed material to the transparent film. The alignment mark on the transparent film is configured to be compared with an alignment mark on the to-be-printed substrate so as to determine whether the alignment mark on the transparent film is aligned with the alignment mark on the to-be-printed substrate in such a manner that when the alignment mark on the transparent film is aligned with the alignment mark on the to-be-printed substrate, it is determined that current positions of the screen printing plate and the to-be-printed substrate are final alignment positions, thereby completing alignment of the screen printing plate with the to-be-printed substrate, and when the alignment mark on the transparent film is not aligned with the alignment mark on the to-be-printed substrate, the current position of the screen printing plate and/or the current position of the to-be-printed substrate are adjusted. The adjustment member is configured to adjust the current position of the screen printing plate and/or the current position of the to-be-printed substrate.

Optionally, the alignment device for screen printing further includes a comparison member. The comparison member is configured to, compare whether the alignment mark on the transparent film is aligned with the alignment mark on the to-be-printed substrate. When the alignment mark on the transparent film is aligned with the alignment mark on the to-be-printed substrate, the comparison member determines that current positions of the screen printing plate and the to-be-printed substrate are final alignment positions, thereby completing alignment of the screen printing plate with the to-be-printed substrate. When the alignment mark on the transparent film is not aligned with the alignment mark on the to-be-printed substrate, the comparison member notifies the adjustment member to adjust the current position of the screen printing plate and/or the current position of the to-be-printed substrate.

Optionally, the alignment device for screen printing further includes a controller configured to, after adjustment of the current position of the screen printing plate and/or the current position of the to-be-printed substrate, remove away the transparent film from the to-be-printed substrate and control the attaching member, the implementing member and the adjustment member to operate repeatedly, until the alignment mark on the transparent film is aligned with the alignment mark on the to-be-printed substrate.

Optionally, the alignment device for screen printing further includes: a removal member configured to remove away the transparent film from the to-be-printed substrate, and a printing member configured to use the screen printing plate to imprint printed material to the to-be-printed substrate.

Optionally, the transparent film is a polyester film or a nylon film, and the transparent film has a thickness in a range of from 0.5 um to 1.5 um.

The above technical solutions of the present disclosure have at least the following benefits.

The screen printing plate is aligned with the to-be-printed substrate by performing a printing test on the transparent film attached to the to-be-printed substrate, and the cost of the transparent film is much lower than that of the dummy substrate for alignment in the related art, the cost of alignment for screen printing is reduced. Further, the alignment method is easy to operate, convenient and quick.

### BRIEF DESCRIPTION OF THE DRAWINGS

FIG. 1 is a flow chart of an alignment method for screen printing process according to one embodiment of the present disclosure;

FIG. 2 is a flow chart of an alignment method for screen printing process according to another embodiment of the present disclosure;

FIG. 3 is a flow chart of an alignment method for screen printing process according to yet another embodiment of the present disclosure;

FIG. 4 is a schematic view of an alignment method for screen printing process according to yet another embodiment of the present disclosure;

FIG. 5 is a block diagram of an alignment device for screen printing process according to one embodiment of the present disclosure; and

FIG. 6 is a schematic view of an alignment method for screen printing process according to still another embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the disclosure. Instead, they are merely examples of devices and methods consistent with aspects related to the disclosure as recited in the appended claims.

In the screen printing process, in order to achieve alignment of the screen printing plate with the glass-cover plate in high precision, before printing, a printing test is first performed on a bare glass which is taken as a dummy substrate. Then, graphical appearance of a printed pattern and a position of the screen printing plate are determined and recorded, thereby completing an indirect alignment of the screen printing plate with the package substrate. Then, an indirect alignment is performed between a mark on the screen printing plate which is pre-aligned and a mark which is formed on the package substrate in a preceding process of the package substrate.

The disadvantages of the above alignment method include: a lot of dummy substrate are wasted, the alignment cannot be performed directly, the indirect alignment is cumbersome and has a large accuracy error which results in a large offset of the printed pattern of frit on the package substrate and a larger offset may be more than 0.08 mm. Thus, the package substrate and the OLED substrate cannot be aligned accurately when the package substrate and the OLED substrate are vacuum-bonded, thereby reducing yield of products.

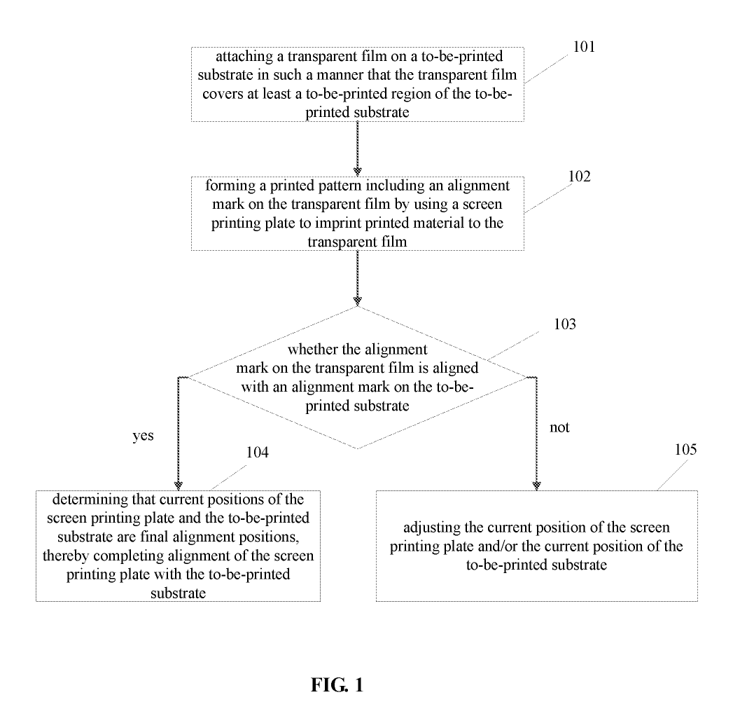

In order to solve the problem in the related art that the alignment method for screen printing process is cumbersome and has low alignment accuracy and high cost, one embodiment of the present disclosure provides an alignment method for screen printing process. Referring to FIG. 1, the method includes an attaching step 101, an implementing step 102, a comparison step 103, a determination step 104 and an adjustment step 105.

The attaching step 101 is to attach a transparent film on a to-be-printed substrate in such a manner that the transparent film covers at least a to-be-printed region of the to-be-printed substrate.

The implementing step 102 is to form a printed pattern including an alignment mark on the transparent film by using a screen printing plate to imprint printed material to the transparent film.

The comparison step 103 is to compare whether the alignment mark on the transparent film is aligned with an alignment mark on the to-be-printed substrate. If yes, the determination step 104 is performed, otherwise, the adjustment step 105 is performed.

The alignment mark on the to-be-printed substrate is formed in a preceding process of the to-be-printed substrate.

The determination step 104 is to determine that current positions of the screen printing plate and the to-be-printed substrate are final alignment positions, thereby completing alignment of the screen printing plate with the to-be-printed substrate.

The adjustment step 105 is to adjust the current position of the screen printing plate and/or the current position of the to-be-printed substrate.

Specifically, only the current position of the screen printing plate is adjusted, or, only the current position of the to-be-printed substrate is adjusted, or the current positions of the screen printing plate and the to-be-printed substrate are adjusted simultaneously.

In one embodiment, before performing formal screen printing, one transparent film is covered on the to-be-printed substrate, a printed pattern including an alignment mark is formed on the transparent film by using the screen printing plate to imprint printed material to the transparent film, and then whether the alignment mark on the transparent film is aligned with an alignment mark on the to-be-printed substrate is determined. If the alignment mark on the transparent film is aligned with the alignment mark on the to-be-printed substrate, the alignment of the screen printing plate with the to-be-printed substrate is completed. If the alignment mark on the transparent film is not aligned with the alignment mark on the to-be-printed substrate, the current position of the screen printing plate and/or the current position of the to-be-printed substrate are adjusted. Before performing formal screen printing, since the screen printing plate is aligned with the to-be-printed substrate by performing a printing test on the transparent film and the cost of the transparent film is much lower than that of the dummy substrate for alignment in the related art, the cost of alignment for screen printing is reduced. Further, the alignment method is easy to operate, convenient and quick.

In one embodiment, in order to further improve alignment accuracy, optionally, after the step of adjusting the current position of the screen printing plate and/or the current position of the to-be-printed substrate, the transparent film on the to-be-printed substrate may be removed, and then the attaching step 101, the implementing step 102, the comparison step 103 and the determination step 104 may be repeatedly performed until the alignment mark on the transparent film is aligned with the alignment mark on the to-be-printed substrate. That is to say, multiple alignments may be performed by repeatedly attaching one transparent film to the to-be-printed substrate.

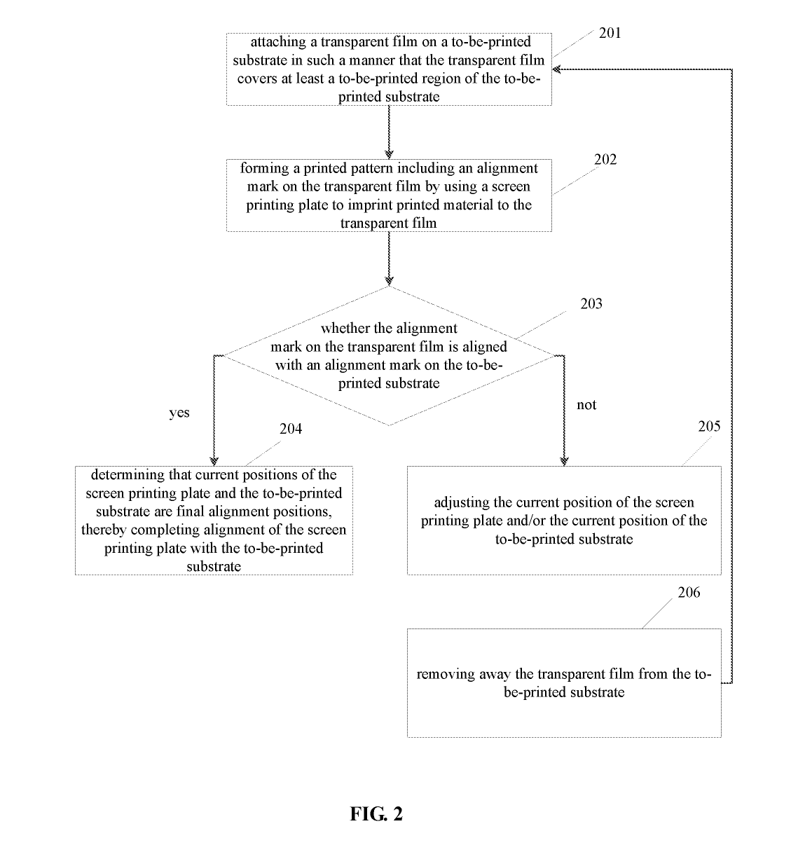

Referring to FIG. 2, one embodiment of the present disclosure further provides another alignment method for screen printing process. Referring to FIG. 2, the method includes an attaching step 201, an implementing step 202, a comparison step 203, a determination step 204, an adjustment step 205, and a removal step 206.

The attaching step 201 is to attach a transparent film on a to-be-printed substrate in such a manner that the transparent film covers at least a to-be-printed region of the to-be-printed substrate.

The implementing step 202 is to form a printed pattern including an alignment mark on the transparent film by using a screen printing plate to imprint printed material to the transparent film.

The comparison step 203 is to compare whether the alignment mark on the transparent film is aligned with an alignment mark on the to-be-printed substrate. If yes, the determination step 204 is performed, otherwise, the adjustment step 205 is performed.

The determination step 204 is to determine that current positions of the screen printing plate and the to-be-printed substrate are final alignment positions, thereby completing alignment of the screen printing plate with the to-be-printed substrate.

The adjustment step 205 is to adjust the current position of the screen printing plate and/or the current position of the to-be-printed substrate.

The removal step 206 is to remove away the transparent film from the to-be-printed substrate and return to perform the step 201 until the alignment mark on the transparent film is aligned with the alignment mark on the to-be-printed substrate

Thus, after the current position of the screen printing plate and/or the current position of the to-be-printed substrate have been adjusted, the transparent film on the to-be-printed substrate is removed away, another transparent film is attached on the to-be-printed substrate again, and then the implementing step 202 and the comparison step 203 are performed again. When it is determined that the alignment mark on the transparent film is aligned with the alignment mark on the to-be-printed substrate, the determination step 204 is performed. When it is determined that the alignment mark on the transparent film is not aligned with the alignment mark on the to-be-printed substrate, the adjustment step 205 and the removal step 206 are performed again.

In other words, multiple alignments may be performed by repeatedly attaching one transparent film to the to-be-printed substrate, until the alignment mark on the transparent film is aligned with the alignment mark on the to-be-printed substrate, thereby greatly improving alignment accuracy. Further, since the transparent film has a lower cost and it is easy to attach or remove the transparent film, the cost of alignment is not increased by repeatedly attaching one transparent film to the to-be-printed substrate.

In the above embodiments, the transparent film may be of various types of transparent films. For example, the transparent film may be a polyester film or a Nylon film. The transparent film may have a thickness in a range of from 0.5 um to 1.5 um. The thickness of the transparent film cannot be too small; otherwise it increases the difficulty of attachment. The thickness of the transparent film cannot be too large, otherwise it affects alignment accuracy. The transparent film may cover the entire to-be-printed substrate, so that it is easy to adjust flatness of the transparent film. Of course, the transparent film may cover only the to-be-printed region of the to-be-printed substrate, so as to save cost.

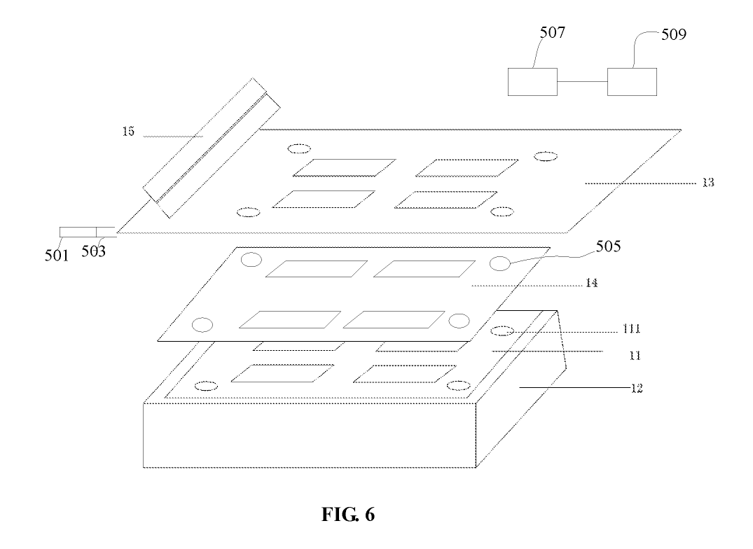

In the above step, the comparison step may be implemented by means of artificial observation, to determine the alignment mark on the transparent film is aligned with the alignment mark on the to-be-printed substrate. In order to improve the degree of automation and alignment accuracy, the comparison step may also be implemented in an automated manner. Specifically, a camera device 507 (as shown in FIG. 6) may be disposed above the to-be-printed substrate and is used to capture a picture of the to-be-printed substrate on which the transparent film is attached, and then a processing circuit 509 (as shown in FIG. 6) is used to analyze and process the captured picture so as to automatically compare whether the alignment mark on the transparent film is aligned with the alignment mark on the to-be-printed substrate and output a comparison result. When the comparison result is that the alignment mark on the transparent film is aligned with the alignment mark on the to-be-printed substrate, it is determined that current positions of the screen printing plate and the to-be-printed substrate are final alignment positions, thereby completing alignment of the screen printing plate with the to-be-printed substrate. When the comparison result is that the alignment mark on the transparent film is not aligned with the alignment mark on the to-be-printed substrate, the current position of the screen printing plate and/or the current position of the to-be-printed substrate are adjusted. The camera device may be an ordinary camera device or an infrared camera device.

In the above embodiments, before the attaching step, it is needed to initially position the to-be-printed substrate and the screen printing plate. In an optional embodiment of the present disclosure, before the attaching step, the method further includes:

positioning horizontally the to-be-printed substrate on a bearing platform; and

securing horizontally the screen printing plate above the to-be-printed substrate.

In the above embodiment, after the determination step, the method further includes: removing the transparent film away from the to-be-printed substrate, and using the screen printing plate to imprint printed material to the to-be-printed substrate.

In other words, after completion of the alignment, the transparent film can be removed away from the to-be-printed substrate, and then formal screen printing is performed on the to-be-printed substrate. Since the screen printing plate has been aligned with the to-be-printed substrate at this time, a printed pattern formed on the to-be-printed substrate for the first time is a qualified printed pattern, thereby avoiding the problems of rework or damage of the to-be-printed substrate caused by an inaccurate alignment for printing, and thereby reducing waste of the to-be-printed substrate.

In an optional embodiment of the present disclosure, the to-be-printed substrate is a package substrate of an OLED substrate, and the printed material is frit.

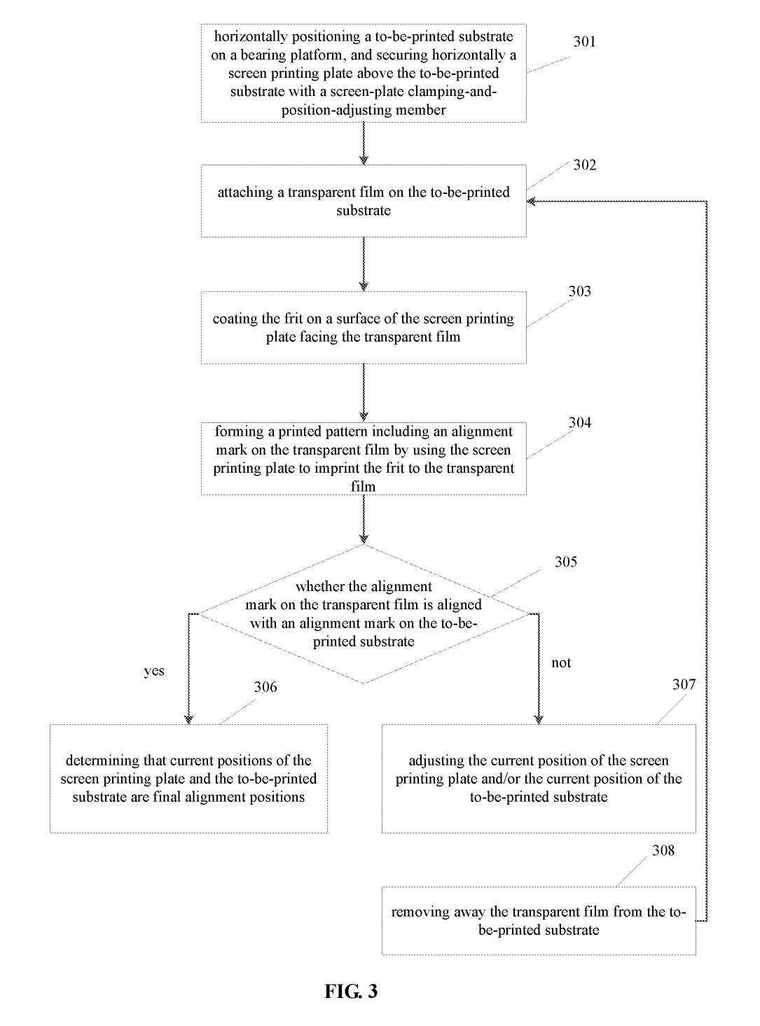

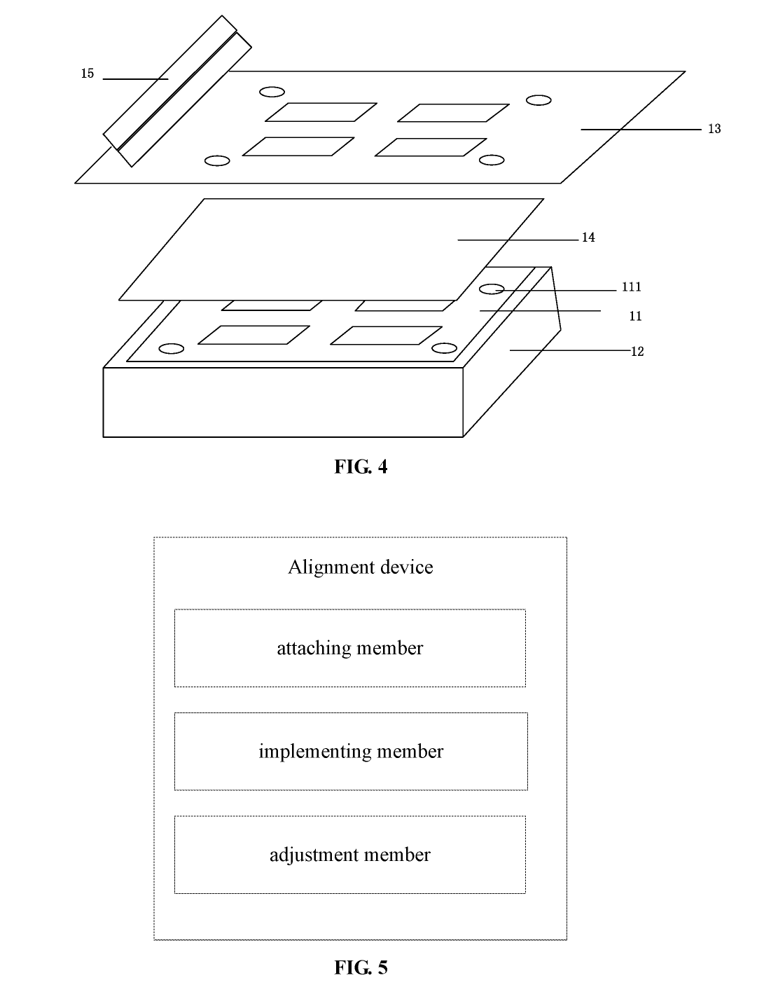

Referring to FIG. 3, FIG. 4 and FIG. 6, one embodiment of the present disclosure further provides an alignment method for screen printing process, which includes an initial positioning step 301, an attaching step 302, a coating step 303, an implementing step 304, a comparison step 305, a determination step 306, an adjustment step 307, and a removal step 308.

The initial positioning step 301 is to horizontally position a to-be-printed substrate 11 on a bearing platform 12, and secure horizontally a screen printing plate 13 above the to-be-printed substrate 11 with a screen-plate clamping-and-position-adjusting member 501, thereby completing initially positioning of the to-be-printed substrate 11 and the screen printing plate 13.

Specifically, the screen printing plate 13 may be secured by a clamp 503 of the screen-plate clamping-and-position-adjusting member 501.

The attaching step 302 is to attach a transparent film 14 on the to-be-printed substrate 11 in such a manner that the transparent film 14 covers the entire to-be-printed substrate 11.

The coating step 303 is to coat the frit on a surface of the screen printing plate 13 facing the transparent film 14.

Specifically, the frit may be evenly stirred for a required amount of time, deaerated and then coated on the screen printing plate 13.

The implementing step 304 is to form a printed pattern including an alignment mark 505 on the transparent film 14 by using the screen printing plate 13 to imprint the frit to the transparent film 14.

Specifically, a cutter (or an imprint knife) 15 may be used to imprint the frit which is coated on the screen printing plate 13 onto the transparent film 14 through the screen printing plate 13.

The comparison step 305 is to compare whether the alignment mark on the transparent film 14 is aligned with an alignment mark 111 on the package substrate 11. If yes, the determination step 306 is performed, otherwise, the adjustment step 307 is performed.

The determination step 306 is to determine that current positions of the screen printing plate 13 and the package substrate 11 are final alignment positions, thereby completing alignment of the screen printing plate 13 with the package substrate 11.

The adjustment step 307 is to adjust the current position of the screen printing plate 13 and/or the current position of the package substrate 11.

Specifically, the current position of the screen printing plate 13 may be adjusted horizontally, and the screen printing plate 13 may be secured again by the clamp.

The removal step 308 is to remove away the transparent film 14 from the package substrate 11 and return to perform the attaching step 302, until the alignment mark 505 on the transparent film 14 is aligned with the alignment mark 111 on the package substrate 11.

The alignment method of one embodiment of the present disclosure uses the transparent films of lower cost to perform a printing test so as to position the screen printing plate with respect to the to-be-printed substrate, without wasting of a lot of dummy substrate. Further, the alignment method is simple is easy to operate, thereby greatly improving printing accuracy of the printed pattern of the frit on the package substrate, and thereby improving alignment accuracy of the OLED substrate with respect to the package substrate and then improving the yield of OLED products.

Based on the same inventive concept, referring to FIG. 5, one embodiment of the present disclosure provides an alignment device for screen printing, which includes an attaching member, an implementing member and an adjustment member.

The attaching member is to attach a transparent film on a to-be-printed substrate in such a manner that the transparent film covers at least a to-be-printed region of the to-be-printed substrate. In one embodiment, the attaching member may use a film attaching device in the related art.

The implementing member is to form a printed pattern including an alignment mark on the transparent film by using a screen printing plate to imprint printed material to the transparent film. The alignment mark on the transparent film is compared with an alignment mark on the to-be-printed substrate so as to determine whether the alignment mark on the transparent film is aligned with the alignment mark on the to-be-printed substrate. When the alignment mark on the transparent film is aligned with the alignment mark on the to-be-printed substrate, it is determined that current positions of the screen printing plate and the to-be-printed substrate are final alignment positions, thereby completing alignment of the screen printing plate with the to-be-printed substrate. When the alignment mark on the transparent film is not aligned with the alignment mark on the to-be-printed substrate, the current position of the screen printing plate and/or the current position of the to-be-printed substrate are adjusted. In one embodiment, as shown in FIG. 3 and FIG. 6, the implementing member may include the screening plate 13 and the imprint knife 15.

The adjustment member is to adjust the current position of the screen printing plate and/or the current position of the to-be-printed substrate. In one embodiment, as shown in FIG. 3 and FIG. 6, the adjustment member may include the clamp 503 for to adjusting the position of the screen printing plate and/or the position of the to-be-printed substrate.

Optionally, the alignment device for screen printing of one embodiment of the present disclosure further includes a comparison member.

The comparison member is to compare whether the alignment mark on the transparent film is aligned with the alignment mark on the to-be-printed substrate. When the alignment mark on the transparent film is aligned with the alignment mark on the to-be-printed substrate, the comparison member determines that current positions of the screen printing plate and the to-be-printed substrate are final alignment positions, thereby completing alignment of the screen printing plate with the to-be-printed substrate. When the alignment mark on the transparent film is not aligned with the alignment mark on the to-be-printed substrate, the comparison member notifies the adjustment member to adjust the current position of the screen printing plate and/or the current position of the to-be-printed substrate. In one embodiment, as shown in FIG. 6, the comparison member may include the camera device 507 disposed above the to-be-printed substrate 11 and the processing circuit 509. The camera device 507 is used to capture a picture of the to-be-printed substrate on which the transparent film is attached. The processing circuit 509 is used to analyze and process the captured picture so as to automatically compare whether the alignment mark on the transparent film is aligned with the alignment mark on the to-be-printed substrate and output a comparison result. The camera device 507 may be a camera. The processing circuit 509 may include a processor. In other words, the comparison may be implemented in an automated manner. Of course, as described above, the comparison may also be implemented by means of artificial observation.

Optionally, in order to further improve alignment accuracy, the alignment device for screen printing of one embodiment of the present disclosure further includes a controller.

The controller is to, after adjustment of the current position of the screen printing plate and/or the current position of the to-be-printed substrate, remove away the transparent film from the to-be-printed substrate and control the attaching member, the implementing member and the adjustment member to operate repeatedly, until the alignment mark on the transparent film is aligned with the alignment mark on the package substrate. In one embodiment, as shown in FIG. 6, the controller may be implemented as a processor.

Optionally, the alignment device for screen printing of one embodiment of the present disclosure further includes a removal member and a printing member.

The removal member is to remove away the transparent film from the to-be-printed substrate.

In one embodiment, as shown in FIG. 3 and FIG. 6, the removal member may be implemented as a clamp 503.

The printing member is to use the screen printing plate to imprint printed material to the to-be-printed substrate. In one embodiment, as shown in FIG. 3 and FIG. 6, the printing member may be implemented as the screen printing plate 13 and the imprint knife 15. Optionally, the transparent film may be a polyester film or a nylon film, and the transparent film may have a thickness in a range of from 0.5 um to 1.5 um.

Optionally, the to-be-printed substrate is a package substrate of an OLED substrate, and the printed material is frit.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. An alignment method for screen printing process comprising:
attaching a transparent film on a to-be-printed substrate in such a manner that the transparent film covers at least a to-be-printed region of the to-be-printed substrate,
forming a printed pattern including an alignment mark on the transparent film by using a screen printing plate to imprint printed material onto the transparent film,
comparing whether the alignment mark on the transparent film is aligned with an alignment mark on the to-be-printed substrate,
determining that current positions of the screen printing plate and the to-be-printed substrate are final alignment positions when the alignment mark on the transparent film is aligned with the alignment mark on the to-be-printed substrate, thereby completing alignment of the screen printing plate with the to-be-printed substrate, and
adjusting at least one of the current position of the screen printing plate and the current position of the to-be-printed substrate when the alignment mark on the transparent film is not aligned with the alignment mark on the to-be-printed substrate.

2. The alignment method of claim 1, wherein after adjusting at least one of the current position of the screen printing plate and the current position of the to-be-printed substrate, the alignment method further includes:
removing the transparent film away from the to-be-printed substrate, and
performing repeatedly preceding process until the alignment mark on another transparent film is aligned with the alignment mark on the to-be-printed substrate.

3. The alignment method of claim 1, wherein the transparent film is a polyester film or a nylon film.

4. The alignment method of claim 3, wherein the transparent film has a thickness in a range of from 0.5 um to 1.5 um.

5. The alignment method of claim 1, wherein the to-be-printed substrate is a package substrate of an OLED substrate, and the printed material is frit.

6. A screen printing process comprising:
attaching a transparent film on a to-be-printed substrate in such a manner that the transparent film covers at least a to-be-printed region of the to-be-printed substrate,
forming a printed pattern including an alignment mark on the transparent film by using a screen printing plate to imprint printed material onto the transparent film,
comparing whether the alignment mark on the transparent film is aligned with an alignment mark on the to-be-printed substrate,
when the alignment mark on the transparent film is not aligned with the alignment mark on the to-be-printed substrate, adjusting at least one of the current position of the screen printing plate and the current position of the to-be-printed substrate, removing the transparent film away from the to-be-printed substrate, and performing repeatedly preceding process until the alignment mark on another transparent film is aligned with the alignment mark on the to-be-printed substrate,
when the alignment mark on the transparent film or the another transparent film is aligned with the alignment mark on the to-be-printed substrate, removing the transparent film or the another transparent film away from the to-be-printed substrate, and using the screen printing plate to imprint printed material to the to-be-printed substrate.

7. The screen printing process of claim 6, wherein the transparent film or the another transparent film is a polyester film or a nylon film.

8. The screen printing process of claim 7, wherein the transparent film or the another transparent film has a thickness in a range of from 0.5 um to 1.5 um.

9. The screen printing process of claim 6, wherein the to-be-printed substrate is a package substrate of an OLED substrate, and the printed material is frit.

10. An alignment device for screen printing comprising:
an attaching member configured to attach a transparent film on a to-be-printed substrate in such a manner that the transparent film covers at least a to-be-printed region of the to-be-printed substrate,
an implementing member configured to form a printed pattern including an alignment mark on the transparent film by using a screen printing plate to imprint printed material to the transparent film, the alignment mark on the transparent film configured to be compared with an alignment mark on the to-be-printed substrate so as to determine whether the alignment mark on the transparent film is aligned with the alignment mark on the to-be-printed substrate in such a manner that when the alignment mark on the transparent film is aligned with the alignment mark on the to-be-printed substrate, it is determined that current positions of the screen printing plate and the to-be-printed substrate are final alignment positions, thereby completing alignment of the screen printing plate with the to-be-printed substrate, and when the alignment mark on the transparent film is not aligned with the alignment mark on the to-be-printed substrate, at least one of the current position of the screen printing plate and the current position of the to-be-printed substrate are adjusted, and
an adjustment member configured to adjust at least one of the current position of the screen printing plate and the current position of the to-be-printed substrate.

11. The alignment device for screen printing of claim 10, further comprising:
a comparison member which is configured to,
compare whether the alignment mark on the transparent film is aligned with the alignment mark on the to-be-printed substrate,
determine that current positions of the screen printing plate and the to-be-printed substrate are final alignment positions when the alignment mark on the transparent film is aligned with the alignment mark on the to-be-printed substrate, thereby completing alignment of the screen printing plate with the to-be-printed substrate, and
notify the adjustment member to adjust at least one of the current position of the screen printing plate and the current position of the to-be-printed substrate when the alignment mark on the transparent film is not aligned with the alignment mark on the to-be-printed substrate.

12. The alignment device for screen printing of claim 11, further comprising:
a controller configured to, after adjustment of at least one of the current position of the screen printing plate and the current position of the to-be-printed substrate, remove away the transparent film from the to-be-printed substrate and control the attaching member, the implementing member and the adjustment member to operate repeatedly until the alignment mark on another transparent film is aligned with the alignment mark on the to-be-printed substrate.

13. The alignment device for screen printing of claim 10, further comprising:
a removal member configured to remove away the transparent film or the another transparent film from the to-be-printed substrate, and
a printing member configured to use the screen printing plate to imprint printed material to the to-be-printed substrate.

14. The alignment device for screen printing of claim 10, wherein the transparent film or the another transparent film is a polyester film or a nylon film, and the transparent film or the another transparent film has a thickness in a range of from 0.5 um to 1.5 um.
